(19) United States
(12) Patent Application Publication
(10) Pub. No.: US 2021/0156292 A1
(43) Pub. Date: May 27, 2021

(54) GAS SENSOR HEAD

(71) Applicant: FAURECIA SYSTEMES D'ECHAPPEMENT, Nanterre (FR)

(72) Inventors: Thibaut CONTREMOULINS, ELSAU (CH); Julien ROUSSILHE, BELFORT (FR); Morgane GULDNER, MONTBELIARD (FR); Sylvain MOLLIER, MANDEURE (FR)

(21) Appl. No.: 17/104,060

(22) Filed: Nov. 25, 2020

(30) Foreign Application Priority Data
Nov. 27, 2019 (FR) 19 13304

(51) Int. Cl. F01N 13/00; F01N 11/00; G01N 1/22

(52) U.S. Cl. CPC F01N 13/008; G01N 29/2418; G01N 1/2252; F01N 11/007

(57) ABSTRACT

A sensor head, capable of sampling and maximizing a stream of gas before transmitting the stream of gas to a sensitive element of a sensor, includes a guide and a capsule. The guide is substantially cylindrical according to a first axis, hollow and closed with an exception of a flow inlet comprising two openings facing each other, pierced in the guide along a second axis substantially perpendicular and coplanar to the first axis, and a flow outlet comprising a hole drilled in the guide along the first axis. The capsule is substantially cylindrical along a third axis substantially parallel to the first axis, including the guide, hollow and closed with an exception of a mouth pierced in the generating surface of the capsule according to a fourth axis substantially perpendicular to the first axis and to the second axis and substantially perpendicular and coplanar to the third axis. A sensor, preferably of the photoacoustic type, includes such a head.

### CROSS-REFERENCE TO RELATED APPLICATIONS

This application is a U.S. non-provisional application claiming the benefit of French Application No. 19 13304, filed on Nov. 27, 2019, which is incorporated herein by reference in its entirety.

### TECHNICAL FIELD

The disclosure relates to the field of gas sensors and more particularly to a head for such a sensor capable of taking a stream of gas from a gas flow and of maximizing this stream of gas before transmitting it to a sensitive element of the sensor.

### BACKGROUND

It is known practice to place a gas sensor in an exhaust pipe in order to measure, in an exhaust gas flow, the concentration of certain components, in particular pollutants, such as NO, NO₂, CO, CO₂, N₂O, NH₃, hydrocarbons, etc.

Such a sensor typically comprises a sensitive element of the photoacoustic type. The principle of such a sensitive element is to emit, via a laser, a pulsed light at a wavelength chosen to be absorbed in the infrared by the molecule whose concentration is to be measured. The molecule absorbs the energy from the pulsed light and releases the excess energy as a change in pressure, creating a sound in the medium. This sound is picked up by a microphone and analyzed to determine the concentration of the molecule.

For this principle to work correctly, the stream of gas treated by the sensing element should have a minimum speed or mass flow, even when the speed or mass flow of the exhaust gas flow is low, for example in engine phases of low load and/or low engine speed. Also it is advisable to maximize the stream of gas before presenting it to the sensitive element.

It is known to use a sensor head to isolate a stream of gas to be analyzed from the main exhaust gas flow. It is known to maximize said stream of gas, before presenting it to the sensing element, by employing active means such as a fan. This is detrimental in that it requires an additional source of energy.

### SUMMARY

The disclosure proposes a sensor head capable, after isolation of a stream of gas, of maximizing the stream of gas, passively, only by way of its conformation.

For this, the disclosure relates to a sensor head, capable of being disposed in an exhaust gas flow, in order to take a stream of gas from said exhaust gas flow and to maximize the stream of gas before transmitting the stream of gas to a sensitive element of the sensor. The sensor head comprises a guide and a capsule, the guide being substantially cylindrical along a first axis, hollow and closed with the exception of a flow inlet comprising two facing slots, pierced in the guide along a second substantially perpendicular axis and coplanar with the first axis, and a flow outlet comprising a hole drilled in the guide along the first axis, the capsule being substantially cylindrical along a third axis substantially parallel to the first axis, including the guide, hollow and closed with the exception of a mouth pierced in the generating surface of the capsule along a fourth axis substantially perpendicular to the first axis and to the second axis substantially perpendicular and coplanar to the third axis.

Particular characteristics or embodiments, which may be used alone or in combination, are:
the fourth axis is coplanar with the first axis,
the mouth and the first axis are located on either side of the third axis,
the mouth and the hole are disposed on either side of a plane perpendicular to the third axis passing through the two facing openings,
the mouth extends mainly around the third axis, preferably symmetrically relative to the fourth axis,
an extension plane of the mouth perpendicular to the third axis does not include the second axis,
a ratio of an outside diameter of the guide to an outside diameter of the capsule is preferably equal to 0.45±20%, a ratio of the outside diameter of the guide to an inside diameter of the capsule is preferably equal to 0.5±20%, a ratio of a diameter of an opening of the two facing openings to the outside diameter of the guide is preferably equal to 0.4±20%, a ratio of a diameter of an opening of the two facing openings to the inside diameter of a capsule is preferably equal to 0.2±20%, a ratio of a height of the mouth to a diameter of an opening of the two facing openings is preferably equal to 0.75±20% or a ratio of an extension of the mouth to the outside diameter of the capsule is preferably equal to 0.63±20%
the guide has an outer diameter of between 9 and 11 mm, preferably substantially equal to 10 mm and an inner diameter of between 7 and 9 mm, preferably substantially equal to 8 mm, the capsule has an outer diameter of between 21 and 23 mm, preferably substantially equal to 22 mm and an internal diameter of between 17 and 19 mm, preferably substantially equal to 18 mm, the two facing openings have a diameter of between 3 and 5 mm, preferably substantially equal to 4 mm, the third axis is at a distance from the first axis of between 2 and 4 mm, preferably substantially equal to 3 mm, the plane perpendicular to the third axis passing through the mouth is at a distance from the second axis of between 1 and 2 mm, preferably substantially equal to 1.5 mm, the mouth has an extension in a plane perpendicular to the fourth axis between 13 and 15 mm, preferably substantially equal to 14 mm, and an extension along the third axis of between 2 and 4 mm, preferably substantially equal to 3 mm, and the capsule has a protuberance in the exhaust pipe of less than 15 mm, preferably less than 12 mm and even more preferably equal to 10 mm.

According to another aspect, the disclosure relates to a sensor comprising a sensitive element capable of measuring a concentration of a molecule in a stream of gas, preferably of the photoacoustic type, and such a head.

According to another aspect, the disclosure relates to an exhaust pipe comprising such a sensor, preferably disposed such that its fourth axis is substantially parallel to the axis of the pipe, the mouth facing the exhaust gas flow.

According to another aspect, the disclosure relates to a vehicle comprising such an exhaust pipe.

### BRIEF DESCRIPTION OF THE DRAWINGS

The disclosure will be better understood upon reading the following description, given purely by way of example, and with reference to the appended figures in which:

FIG. 1 shows a perspective view of an embodiment of the head according to the disclosure,

FIG. 2 shows an exploded perspective view of the same embodiment,

FIGS. 3a and 3b show respectively in front view and in sectional view profiles of the same embodiment,

FIG. 4 shows a perspective view of a capsule according to the disclosure,

FIGS. 5a, 5b, 5c, and 5d show respectively in sectional front view, in front view, in profile view and in top view, the same capsule,

FIG. 6 shows a perspective view of a guide according to one embodiment of the disclosure,

FIGS. 7a, 7b and 7c show respectively in bottom view, in front view and in cut profile view, the same guide, and

FIGS. 8, 9 and 10 show in perspective view a guide respectively according to other embodiments of the disclosure.

### DETAILED DESCRIPTION

A sensor head 1 is suitable for being placed in an exhaust gas flow, in order to take a stream of gas from said exhaust gas flow and to maximize the stream of gas before transmitting it to a sensitive element of the sensor.

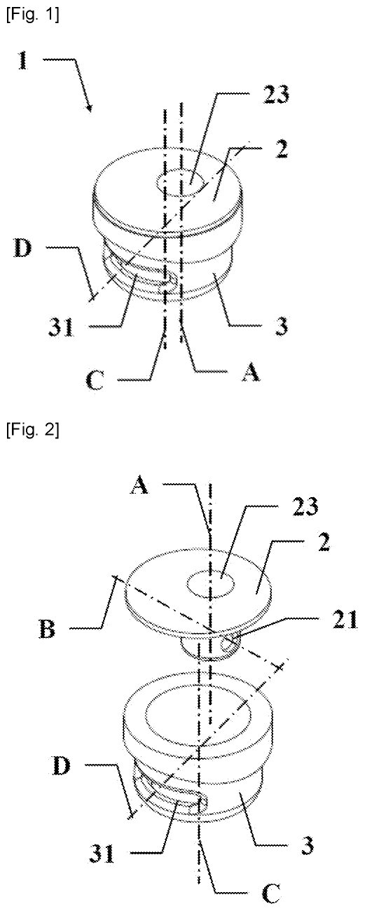

For this, as illustrated in FIG. 1, 2, 3a or 3b, a head 1 comprises a guide 2 and a capsule 3. The guide 2 is substantially cylindrical along a first axis A, shown vertically in the perspective figures.

This cylinder is hollow in order to form a pipe. It is closed over its entire cylindrical surface, with the exception of a flow inlet comprising two openings 21, 22 and a flow outlet comprising a hole 23. The two openings are arranged opposite one another and are drilled in the guide 2 along a second axis B substantially perpendicular to the first axis A. The second axis B intersects the first axis A, in other words, the second axis B and the first axis A are coplanar. Thus the openings 21, 22 are drilled in the generating surface of the cylinder and are centered on the first axis A, the latter intersecting the axis B of the openings 21, 22. The hole 23 is drilled in the guide 2 along the first axis A. Thus the hole 23 is placed in an end surface of the cylinder.

The capsule 3 is also substantially cylindrical along a third axis C. When the guide 2 and the capsule 3 are assembled, the third axis C is substantially parallel to the first axis A. The capsule 3 is shaped to contain the guide 2. The capsule 3 is hollow in order to form a pipe. It is closed over its entire cylindrical surface, with the exception of a mouth 31 pierced in the generating surface of the capsule 3 along a fourth axis D substantially perpendicular to the first axis A, to the second axis B and to the third axis C. In addition, the fourth axis D is coplanar with the third axis C. The capsule 3 is still open at its interface with the guide 2, at least opposite the outlet 23, in order to allow the hole 23 to emerge from the head 1.

Thus when the head 1 is placed in a gas flow, such as an exhaust gas, for example by disposing the head 1 against a wall of an exhaust gas pipe, i.e. the first axis A and the second axis C substantially perpendicular to said wall, and the fourth axis D disposed substantially parallel to the direction of the exhaust gas flow so that the mouth 31 opens facing said exhaust gas flow, the head 1 is able to allow entry into the mouth 31 of a stream of gas.

This stream of gas is thus isolated from the rest of the exhaust gas flow. This stream of gas enters via the mouth 31 into the interior volume of the capsule 3. The opening of the mouth 31 is such that it maximizes the stream of gas entering the capsule 3 by limiting the streams of gas exiting through the mouth 31. The stream of gas meets the external surface of the guide 2 and enters the latter via the two openings 21, 22. The stream of gas then circulates inside the guide 2 and comes out through the hole 23. At the exit of the hole 23 the stream of gas is brought into contact with the sensitive element of the sensor.

The hole 23 is advantageously disposed in the wall of the pipe, itself pierced opposite, in order to allow the sensitive element to be disposed outside the exhaust pipe.

The path of the stream of gas inside the capsule 3, outside then inside the guide 2 advantageously allows, due to the shape of the pipe jointly formed by the capsule 3 and by the guide 2, to achieve a maximization of the stream of gas, prior to its presentation to the sensitive element. This maximization is obtained, according to a first characteristic, by a difference between the section of the inlet mouth 31 clearly greater than the section of the outlet hole 23. Thus, as a result of the funnel effect, the gas flow is increased. According to another characteristic, a vortex is created. This vortex, by creating a turbulent circulation, increases the flow rate of the stream of gas and thus the quantity of gas presented to the sensitive element. The creation of the vortex may, for example, result from the presence of the guide 2 and is improved by the eccentricity of the guide 2 relative to the capsule 3. Advantageously, this vortex makes it possible secondarily to eject, by centrifugal effect, possible particles before the stream of gas enters the guide 2, preventing them from reaching the sensitive element. According to a third characteristic, all the shapes of the head 1, particularly those in contact with the gas flow, are optimized to limit the pressure losses to a minimum, in order to improve the flow of gas through the head 1. Thus, according to this third characteristic the gas flow is maximized in that it is not reduced or reduced as little as possible, or, in other words, the stream of gas is kept to the maximum.

According to another characteristic, the fourth axis D is coplanar with the first axis A. Thus the guide 2 is disposed symmetrically, relative to the axis D of the stream of gas in the capsule 3. The head 1 thus has plane symmetry relative to the stream of gas axis D and, more particularly, a symmetry relative to the plane AD containing the first axis A and the fourth axis D.

According to another characteristic, the mouth 31 and the first axis A of the guide 2 are located on either side of the third axis C. Thus, along the fourth axis D, longitudinal in the plane of the figures, the mouth 31 is disposed on one side of the axis C of the capsule 3, while the guide 2 is disposed on the other side of said axis C.

According to another characteristic, the mouth 31 and the hole 23 are disposed on either side of a plane perpendicular to the third axis C passing through the openings 21, 22. Thus along a vertical axis C in the plane of the figures, the mouth 31 is located at a first height, the openings 21, 22 are located at another higher height, while the hole 23 is located at another height even higher than the other two heights. Such an arrangement facilitates the flow of the stream of gas in that it reduces its length, thus limiting pressure drops.

According to another characteristic, the mouth 31 extends mainly around the third axis C, preferably symmetrically relative to the fourth axis D. Thus the mouth 31 has substantially the shape of a slot extending on the generating surface of the cylinder of the capsule 3, or in a plane perpendicular to the third axis C.

According to another characteristic, the extension plane of the mouth 31, perpendicular to the third axis C, does not contain the second axis B. Thus the openings 21, 22 are not coplanar with the mouth 31. They are advantageously disposed at a different height according to the third axis C.

The dimensions of the head 1 may be varied. However, some proportions are more advantageous than others, especially in terms of accelerating the stream of gas. Several configurations, with different dimensional characteristics, were compared in simulation, with regard to the acceleration characteristic of the stream of gas.

Also, according to one characteristic, it is possible to dimensionally define a head 1, using at least one of the following proportions.

The ratio of the outside diameter of the guide 2 to the outside diameter of the capsule 3 is preferably equal to 0.45±20%. The ratio of the outside diameter of the guide 2 to the inside diameter of the capsule 3 is preferably equal to 0.5±20%. The ratio of the diameter of an opening 21, 22 to the outside diameter of the guide 2 is preferably equal to 0.4±20%. The ratio of the diameter of an opening 21, 22 to the inside diameter of a capsule 3 is preferably equal to 0.2±20%. The ratio of the height of the mouth 31 to the diameter of an opening 21, 22 is preferably equal to 0.75±20%. The ratio of the extension of the mouth 31 to the outer diameter of the capsule 3 is preferably equal to 0.63±20%.

It should be noted that all of these ratios are completely independent of each other.

According to another characteristic, the guide 2 has an outside diameter of between 9 and 11 mm and an inside diameter of between 7 and 9 mm, the capsule has an outside diameter of between 21 and 23 mm and an inside diameter of between 17 and 19 mm, the openings 21, 22 have a diameter of between 3 and 5 mm, the third axis C is at a distance from the first axis A of between 2 and 4 mm, the plane perpendicular to the third axis C passing through the mouth 31 is at a distance from the second axis B of between 1 and 2 mm and the mouth 31 has an extension, in a plane perpendicular to the fourth axis D, of between 13 and 15 mm and an extension along the third axis C of between 2 and 4 mm. According to another preferred characteristic, the guide 2 has an outer diameter substantially equal to 10 mm and an inner diameter substantially equal to 8 mm, the capsule 3 has an outer diameter substantially equal to 22 mm and an inner diameter substantially equal to 18 mm, the openings 21, 22 have a diameter substantially equal to 4 mm, the third axis C is at a distance from the first axis A substantially equal to 3 mm, the plane perpendicular to the third axis C passing through the mouth 31 is at a distance from the second axis B substantially equal to 1.5 mm, the mouth 31 has an extension, in a plane perpendicular to the fourth axis D, substantially equal to 14 mm and an extension along the third axis C is substantially equal to 3 mm, while the capsule 3 has a protuberance P in the exhaust pipe of less than 15 mm, preferably less than 12 mm and more preferably equal to 10 mm.

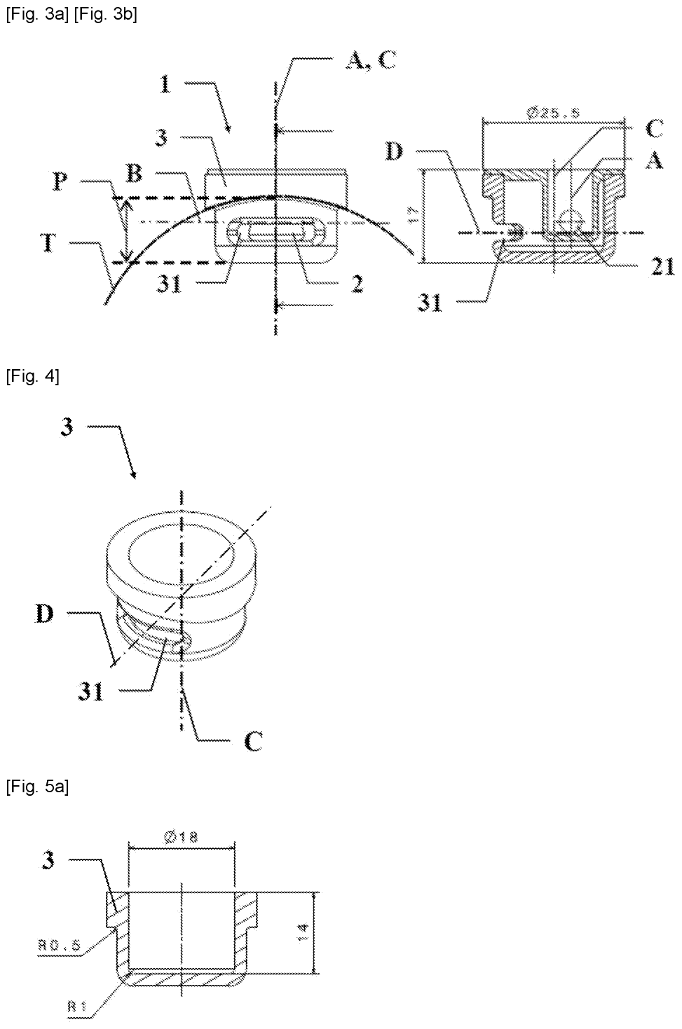

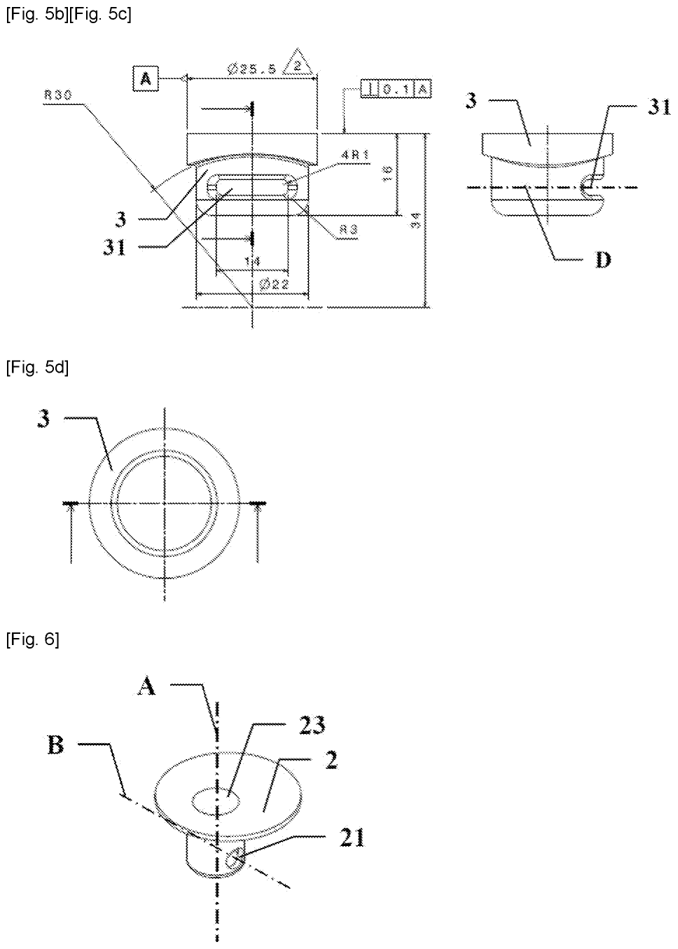

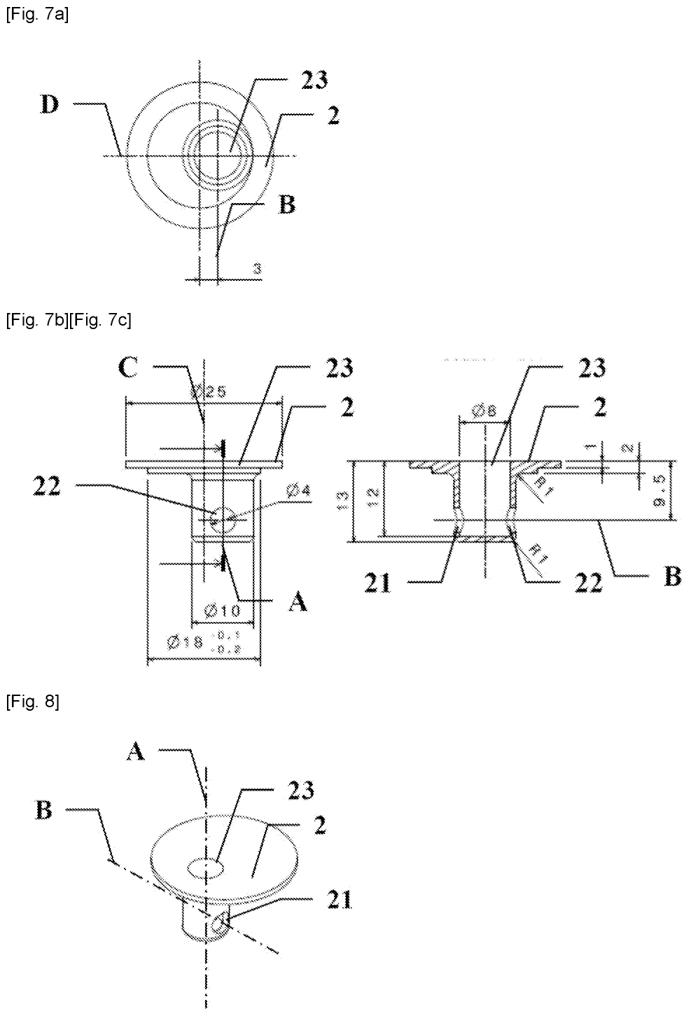

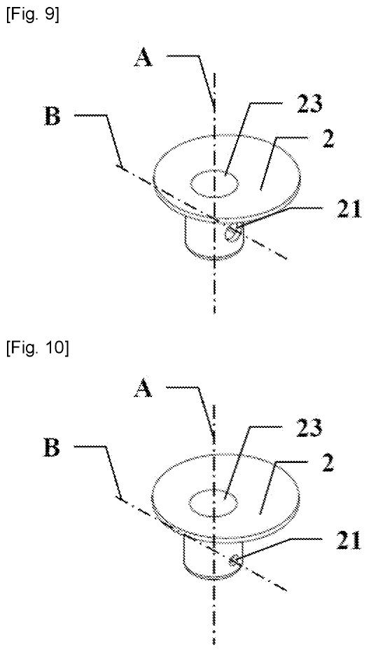

This protuberance P is more particularly illustrated in FIG. 3a. The capsule 3 is inserted into an exhaust pipe T, the plate thickness of which is between 1 and 1.5 mm. The smallest possible protuberance P should be presented.

The distance between the first axis A and the third axis C makes it possible to create an eccentricity, capable of creating a swirling effect.

It should be noted that all of these dimensions are completely independent of one another.

It may be noted that the addition of the guide 2 and its eccentric positioning in the head 1, as described previously, makes it possible to multiply the stream of gas by a factor of 5, relative to a head 1 without a guide 2. Thus if a head 1 without a guide 2, reduced to the single capsule 3, allows a stream of gas arriving at the sensitive element of 1 mg/s, the addition of a centered guide 2, makes it possible to increase this stream of gas to 3 mg/s, wherein an eccentric guide 2 according to the disclosure, all other things being equal, makes it possible to increase this stream of gas to 5 mg/s.

The disclosure also relates to a sensor comprising a sensitive element capable of measuring a concentration of a molecule in a stream of gas, preferably of the photoacoustic type, and a head 1 according to any one of the embodiments described above.

The disclosure also relates to an exhaust pipe comprising such a sensor according to the preceding claim, preferably disposed such that its fourth axis D is substantially parallel to the axis of the pipe, the mouth 31 facing the stream of gas.

The disclosure also relates to a vehicle comprising such an exhaust pipe.

The disclosure has been illustrated and described in detail in the drawings and the foregoing description. This should be considered as illustrative and given by way of example and not as limiting the disclosure to this description alone. Many variant embodiments are possible.

1. A sensor head for a sensor, suitable for being disposed in an exhaust gas flow, in order to take a stream of gas from said exhaust gas flow and to maximize the stream of gas before transmitting the stream of gas to a sensitive element of the sensor, wherein the sensor head comprises:
a guide that is cylindrical along a first axis, hollow and closed with an exception of a flow inlet comprising two facing openings, pierced in the guide along a second axis perpendicular and coplanar to the first axis, and a stream of gas outlet comprising a hole drilled in the guide along the first axis; and
a capsule that is cylindrical along a third axis parallel to the first axis, including the guide, hollow and closed with an exception of a mouth pierced in a generating surface of the capsule along a fourth axis perpendicular to the first axis and to the second axis and perpendicular and coplanar to the third axis.

2. The sensor head according to claim 1, wherein the fourth axis is coplanar with the first axis.

3. The sensor head according to claim 1, wherein the mouth and the first axis are located on either side of the third axis.

4. The sensor head according to claim 1, wherein the mouth and the hole are disposed on either side of a plane perpendicular to the third axis passing through the two facing openings.

5. The sensor head according to claim 1, wherein the mouth extends mainly around the third axis.

6. The sensor head according to claim 5, wherein the mouth extends symmetrically relative to the fourth axis.

7. The sensor head according to claim 1, wherein a plane of extension of the mouth perpendicular to the third axis, does not include the second axis.

8. The sensor head according to claim 1, where
a ratio of an outside diameter of the guide to an outside diameter of the capsule is equal to 0.45±20%,
a ratio of the outside diameter of the guide to an inside diameter of the capsule is equal to 0.5±20%,
a ratio of a diameter of an opening of the two facing openings to the outside diameter of the guide is equal to 0.4±20%,
a ratio of a diameter of an opening of the two facing openings to the inside diameter of the capsule is equal to 0.2±20%,
a ratio of a height of the mouth to a diameter of an opening of the two facing openings is equal to 0.75±20%, and
a ratio of an extension of the mouth to the outside diameter of the capsule is equal to 0.63±20%.

9. The sensor head according to claim 1, wherein
the guide has an outer diameter of between 9 and 11 mm, and an inner diameter of between 7 and 9 mm,
where the capsule has an outer diameter of between 21 and 23 mm and an inner diameter of between 17 and 19 mm,
where the two facing openings have a diameter of between 3 and 5 mm,
where the third axis is at a distance from the first axis of between 2 and 4 mm,
where a plane perpendicular to the third axis passing through the mouth is at a distance from the second axis of between 1 and 2 mm,
where the mouth presents an extension in a plane perpendicular to the fourth axis between 13 and 15 mm, and an extension along the third axis between 2 and 4 mm, and
where the capsule has a protuberance in the exhaust pipe of less than 15 mm.

10. A sensor comprising:
a sensitive element capable of measuring a concentration of a molecule in a stream of gas; and
a sensor head suitable for being disposed in an exhaust gas flow, in order to take a stream of gas from said exhaust gas flow and to maximize the stream of gas before transmitting the stream of gas to the sensitive element of the sensor, wherein the sensor head comprises
a guide that is cylindrical along a first axis, hollow and closed with an exception of a flow inlet comprising two facing openings, pierced in the guide along a second axis perpendicular and coplanar to the first axis, and a stream of gas outlet comprising a hole drilled in the guide along the first axis, and
a capsule that is cylindrical along a third axis parallel to the first axis, including the guide, hollow and closed with an exception of a mouth pierced in a generating surface of the capsule along a fourth axis perpendicular to the first axis and to the second axis and perpendicular and coplanar to the third axis.

11. An exhaust pipe comprising the sensor according to claim 10, arranged such that the fourth axis is parallel to an axis of the exhaust pipe, the mouth facing the stream of gas.

12. A vehicle comprising the exhaust pipe according to claim 11.

13. The sensor head according to claim 1, where
a ratio of an outside diameter of the guide to an outside diameter of the capsule is equal to 0.45±20%,
a ratio of the outside diameter of the guide to an inside diameter of the capsule is equal to 0.5 ±20%,
a ratio of a diameter of an opening of the two facing openings to the outside diameter of the guide is equal to 0.4±20%,
a ratio of a diameter of an opening of the two facing openings to the inside diameter of the capsule is equal to 0.2±20%,
a ratio of a height of the mouth to a diameter of an opening of the two facing openings is equal to 0.75±20%, or
a ratio of an extension of the mouth to the outside diameter of the capsule is equal to 0.63±20%.

14. The sensor head according to claim 1, wherein
the guide has an outer diameter of between 9 and 11 mm, and an inner diameter of between 7 and 9 mm,
where the capsule has an outer diameter of between 21 and 23 mm and an inner diameter of between 17 and 19 mm,
where the two facing openings have a diameter of between 3 and 5 mm, where the third axis is at a distance from the first axis of between 2 and 4 mm,
where a plane perpendicular to the third axis passing through the mouth is at a distance from the second axis of between 1 and 2 mm,
where the mouth presents an extension in a plane perpendicular to the fourth axis between 13 and 15 mm, and an extension along the third axis between 2 and 4 mm, or
where the capsule has a protuberance in the exhaust pipe of less than 15 mm.
